(19) United States
(12) Patent Application Publication
(10) Pub. No.: US 2024/0068557 A1
(43) Pub. Date: Feb. 29, 2024

(54) BEARING ARRANGEMENT AND EPICYCLIC GEARBOX WITH ELASTIC ELEMENTS

(71) Applicant: Rolls-Royce Deutschland Ltd & Co KG, Blankenfelde-Mahlow (DE)

(72) Inventor: Lucia CICIRIELLO, Potsdam (DE)

(21) Appl. No.: 17/893,919

(22) Filed: Aug. 23, 2022

(51) Int. Cl. F16H 57/08; F16H 1/28; F16H 57/023

(52) U.S. Cl. CPC F16H 57/082; F16H 1/28; F16H 57/023; F01D 25/16; F16H 2057/085

(57) ABSTRACT

A bearing arrangement includes; a carrier supported by a support structure and a rotatable element having a support surface and being rotatably mounted by means of a bearing, the bearing having a component providing a bearing surface for the rotatable element, wherein a gap between the bearing surface and a surface of the rotatable element is filled with a fluid; wherein an elastic element arrangement with at least one deformable elastic element is provided so as to elastically act on the component of the bearing and a component of the carrier, wherein the rotatable element is supported via its support surface against the support structure with a support stiffness, and wherein the elastic element arrangement has a stiffness that is smaller than the support stiffness.

### BACKGROUND

The present disclosure relates to a bearing arrangement, an epicyclic gearbox and to an engine comprising such a journal bearing arrangement and/or such an epicyclic gearbox. The present disclosure further relates to a corresponding manufacturing method.

A common problem in the field of rotating machinery is controlling the level of vibration. Vibration may be caused by imbalances of rotating parts, such as a planet gear on a pin, or a shaft and supported rotatable elements, such as, e.g., compressor and turbine discs and blades in gas turbine engines, and also external forcing such as, e.g., aircraft maneuvers, transient and oscillating loads, and aerodynamic forces in an aircraft. In hydrodynamic journal bearings and other components, fluid-excited instabilities and troublesome modulations of the loads may occur at certain operating conditions, in particular at high speeds and, depending on a respective gearbox design, dynamic loads generating instabilities can also appear at high-power conditions, where both speed and torque are approaching to their respective maximum value as per the design intent of the gearbox, Oil film induced vibrations may cause additional dynamic (in particular cyclic) displacements onto the rotating parts, for instance in a gearbox, that have the consequence to modulate a radial distance between rotor and stator of a journal bearing chamber (or gap), and to create modulations in the oil pressure as well as in tangential friction forces for a unitary area, which are equal to pressure forces integrated on the unitary area multiplied by the friction coefficient. Once triggered by an initial gap variation, the pressure modulation can generate forces that are radial to the journal bearing, as well as tangential forces. The friction coefficient accounts for the friction between oil particles and between the oil particles and the metal or coating of the internal surfaces of the bearing chamber. These forces can have a magnitude that cyclically variates whilst the rotor is spinning, due to the minimum gap changing; in particular the tangential forces can become able to force the rotor into a precessional sustained orbit. Precession orbits may appear in superposition with the spinning of the rotating part and appear combined in different ways depending on the possibilities given by the system clearances and degrees of freedom of the rotating parts.

Precession orbits can be backwards or forwards with respect to the sense of rotation and this usually also changes the frequency in the vibrational signature when the vibration is captured by a sensor on a fixed frame. When the oil film induced vibrations can freely increase the orbits of the rotating part within the available clearances, the vibration level measured at the static parts of the gearbox, such as the ring gear of a planetary gearbox, can become considerably high as a consequence of the relative displacements induced by the orbits of one or more of the geared rotors. It is worth noting that the precession orbit can generate relative displacements between a pin and a planet, or between a sun and a planet, that are in fact opposite to the gap reduction that has initially triggered the orbit. In fact, the orbit corresponds to the reactive force that the oil film exerts in response to the initial overpressure, with the effect of releasing the oil pressure, but only until the initial condition is built up again across the period of the cyclic precessional orbit and load modulation. It is also worth noting that the precession load modulation frequency, or frequency of the orbit, is the inverse of the time that the journal minimum gap and a point fixed on the orbiting rotor take to be again at the same relative position. Instead, in case the rotating part(s) is (are) prevented to orbit any further, because the clearances are locked up by the friction and elastic deformation due to the circulating torque, then the overpressure due to the initial gap reduction combined with the spinning of the rotor may generate relative displacements that compress the oil even further, with higher tangential forces that in this case cannot react pushing back neither the pin nor the rotor, In this case, the tangential forces built up the kinetic energy of the oil film, bringing the oil mass in rotation and so that augmenting the oil velocity relative to the rotor, If the pin-carrier connections are very stiff, then the oil gap cannot find a release back to its original position, and so the oil velocity is further increased. This augment of tangential motion in the oil film mass usually generates a loss of load capacity of the journal bearing, with an overtemperature (that means an oil temperature increase) that can be quite abrupt, and with a consequent separation of air from oil, if mist is present in the journal chamber. So, dynamic conditions may create onsets which can be measured in sensors and that are similar to oil starvation. It is worth noting that if one or more resonances are excited in the gearbox, the gap variation can be largely affected and in most of the cases, aggravated. In the same manner, the level of unbalance, that is, the magnitude of the forcing function of the synchronous orbits in resonance, may largely influence the gap variation.

Oil film induced vibrations can appear both in a stable or instable onset, the difference depending on whether the magnitude of the vibration and the orbits remains constant versus time, in stationary speed and loads, or increases rapidly also at steady conditions.

Stable oil film-induced vibrations are often indicated with the term oil whirl (wherein the term whirl relates to orbits), whilst with the term the oil whip vibrations having a divergent, commonly instable behavior are indicated. The oil whip has the same mechanism as the oil whirl but can be more critical and is mostly instable, because in this case the periodic force induced by the oil film excites a resonance of the rotating part that has the effect of variating the gap even further. Even though this distinction is correct in most cases, there are also instable oil whirl and relatively stable oil whip (the latter being anyways dangerous because the rotating part can suddenly become incontrollable causing metal to metal contacts). It is worth noting that the oil whip may force an orbit correspondent to a stiff shaft constraint, whereas the oil whirl is in general present when there are clearances that allow the oil film-forced orbits also to be out of resonance.

Oil whirl can be sub-synchronous or synchronous with respect to the rotating part. Whether the precessional orbit is travelled, e.g., at about half of the speed of the rotating part or at a speed close or equal to its speed, depends on speed and load conditions from the oil dynamic viscosity and the oil mist present in the journal bearing chamber. The frequency at which the precessional orbit is travelled is related to the average tangential speed of the oil film mass contained in the journal bearing which in turn is related to the oil pressure and temperature variation and friction values. When oil whirl and oil whip set in, hydraulic forces may destabilize and increase the motion of the rotating part and induce a self-excited vibration. Such a vibration typically has very high amplitudes.

Orbits due to gap-dependent forces in a journal bearing planet or due to non-linear mesh contacts can generate overloads. Due to potentially high magnitudes of radial, axial and tangential (friction) loads that can be developed by the planet journal bearing as a reaction from the oil film being forced into a smaller gap, the gap-dependent forces and vibration in epicyclic gearboxes have the potential to generate major defects in the gearbox or connected parts. In the case of an epicyclic gearbox of an aircraft, this may lead to issues in flight.

### SUMMARY

It is an object to reduce vibrations that may reduce the performance and decrease the lifetime of assemblies such as epicyclic gearboxes.

According to a first aspect there is provided a (e.g., journal) bearing arrangement for an assembly, e.g., for an epicyclic gearbox. The (journal) bearing arrangement comprise a carrier being supported by a support structure and a rotatable element having a support surface and being rotatably mounted by means of the (journal) bearing, the (journal) bearing having a component providing a bearing surface for the rotatable element, wherein a gap between the bearing surface and a surface of the rotatable element is filled with a fluid (e.g., an oil). Therein, an elastic element arrangement with at least one deformable elastic element is provided so as to elastically act on the component of the (journal) bearing and a component of the carrier, wherein the rotatable element is supported via its support surface against the support structure with a support stiffness, and wherein the elastic element arrangement has a stiffness that is smaller than the support stiffness.

The rotatable element may be a shaft or a gear. The support surface may form teeth of the gear. Further, the assembly may be or comprise a seal and/or a squeeze film bearing, an air bearing, a magnetic bearing or an electrical motor (axial or radial). The bearing may define the gap of the respective assembly.

According to an aspect, there is provided an epicyclic gearbox. The epicyclic gearbox may comprise one or more journal bearing arrangements as described above. Specifically, the epicyclic gearbox comprises a planet carrier supported by a support structure, a ring gear, a sun gear and planet gears, wherein each of the planet gears has teeth (with a support surface) and is meshing with the ring gear and with the sun gear. Each planet gear is rotatably mounted by means of a journal bearing. Each of the journal bearings has a component providing a bearing surface for the respective planet gear. A gap between the bearing surface and a surface of the planet gear, for ease of reference also indicated as planet surface, is filled with an oil. Therein, for at least one of the planet gears an elastic element arrangement with at least one deformable elastic element is provided so as to elastically act on (optionally to elastically pretension) the component of the journal bearing of the respective planet gear and a component of the planet carrier. The planet gears are supported, via their respective teeth, against the support structure with a support stiffness Ks. Therein, the elastic element arrangement has a stiffness Kel that is smaller than the s stiffness Km.

The stiffness of the elastic elements can be designed to be able to reduce, and dissipate by means of its deformation, the orbital movements that appear under the effect of dynamic forces/modulations caused by a gap reduction in the journal bearing. Both for the journal bearing arrangement and for the epicyclic gearbox, this is based on the finding that orbit motions of planet carrier, sun gear and planet gears can become higher in amplitude and more persistent when the carrier-to-pin connection is very rigid even if the ring gear mounting is relatively soft. In this case a variation of the gap will tend to induce a larger variation of the gap as a consequence because the gear train elements are stiff and the ring gear mounting flexibility cannot compensate a gap variation, because it cannot affect directly the relative displacements between the planet carrier and planet gears or between the planet gears and the sun gear. Therein, the stiffness of the elastic elements is dimensioned so that when the gears undergo orbits, the elastic elements are those that are deformed at first. These one or more elastic elements can then effectively allow the reactive orbit to be compensated and because of the structural damping bounced back at a lower amplitude. The stiffness and damping of the element elements can be designed so that the initial gap variation that initiates the orbit is then reduced, thus cutting the instable mechanism. Thereby, a damage of other parts of the epicyclic gearbox or other parts connected to it can be avoided. This allows to reduce a loss of performance as well as to reduce vibrations and their effect in the epicyclic gearbox, and to increase the lifetime of the epicyclic gearbox and parts connected to it.

The stiffness Kel of the elastic element arrangement (of the journal bearing arrangement and/or the epicyclic gearbox) may be one or two orders of magnitude smaller than the support stiffness Ks. Thus, the stiffness of the elastic element arrangement may be at least 10 times smaller, in particular at least 100 times smaller than the support stiffness Ks The support stiffness Ks corresponds to the stiffness of the geared connections between the respective planet gear and the support structure. The support structure may be regarded as a stiff reference, This allows to ensure that the initial orbiting movements almost only deform the one or more elastic elements. Notably, the planet carrier may be supported on the support structure (rotatably or fixedly). The component of the planet carrier is supported against the support structure with a carrier stiffness Kca. The stiffness Kel of the elastic element arrangement may be smaller than the carrier stiffness Kca; e.g., Kel=0.* Kca.

It is worth noting that the radial, axial and tangential stiffness of the connections between pins and carrier determines the gap variation, together and in relation with the ring gear mounting axial, radial and tangential stiffness. All the other connections, such as roller bearings and gear mesh points are in general very stiff, therefore are the connections pin-to-carrier and the ring gear mounting that largely determine the gap variation, in the journal bearings as well as in seals, squeeze film bearings and in the space between gear where oil trapping may occur. To this extent, elastic elements to absorb the loads to unwanted gap variation, can be designed to prevent unwanted oil dynamic forces and orbits to be generated in seals, squeeze film bearings, space between gears (e.g., oil trapping) etc. Advantageously, the radial and axial stiffness of the carrier-to-pin connections can be designed to be the first element of the whole gear train to undergo an elastic deformation when forces are developed by a variation of an oil or air gap. Designing the stiffness of such elastic elements to be lower than the other connections and components in a gear train, the relative displacements that affect the gap can be controlled, for instance to remain confined between a minimum and maximum value. It is worth noting that clearances may be present to accommodate relatively small displacements between parts.

The elastic element arrangement (of the journal bearing arrangement and/or the epicyclic gearbox) may prevent rotation of the component of the journal bearing with respect to the component of the (planet) carrier. Alternatively, a second component having high torsional stiffness can be added to prevent relative rotations (e.g., anti-rotation wedges of toothed connections. By this, unwanted movements can be avoided. Notably, radial and axial elastic elements (e.g.; springs) may be separated by an anti-rotation mechanism.

The elastic element arrangement (of the journal bearing arrangement and/or the epicyclic gearbox) may comprise a plurality of deformable elastic elements, e.g., 4, 5 or more elastic elements. This allows a uniform absorption of vibrations. The elastic elements can have a radial, axial and/or tangential stiffness designed in several combinations to address all possible relative displacements, e.g., also to orbits combined with axial movements.

The stiffness Kel of the elastic element arrangement (of the journal bearing arrangement and/or the epicyclic gearbox) may be calculated in a given direction. The stiffness of the elastic element arrangement may be calculated as the equivalent stiffness of the stiffness values of the individual elastic elements of the respective planet gear with respect to the given direction. The equivalent stiffness may comprise stiffnesses in series and/or in parallel. The stiffnesses may be regarded in radial, axial and/or tangential direction. This allows a precise setup.

The support stiffness Ks (of the journal bearing arrangement and/or the epicyclic gearbox) can be calculated as the inverse of the sum of inverse stiffness values, wherein the inverse stiffness values comprise inverse stiffness values of the ring gear, the sun gear, the planet gear and/or their respective mounts on the support structure. This allows a precisely tuned setup.

An elastic element arrangement may be provided for each of the planet gears. Thereby, backward, and forward orbits of the planet carrier, sun gear and one or more planet gears that are due to oil film pressure, that in turn may generate tangential forces, may be reduced. Notably, several orbits may occur in combination.

Optionally, the elastic element arrangement (of the journal bearing arrangement and/or the epicyclic gearbox) comprises an elastic element that acts in a radial direction and another elastic element that acts in an axial direction (with respect to the rotational axis of the respective planet gear). Alternatively, or in addition, the elastic element arrangement comprises an elastic element that acts in a radial direction and in an axial direction. Since vibrations can also occur axially, this allows to further reduce vibrations. It is worth noting that the concept of using one or more of the localized axial, radial and/or tangentially acting elastic elements (e.g., spring(s)), can be extended to a modular design where several localized elastic elements are combined and assembled together.

The component of the journal bearing of the respective planet gear may be, or be fixedly connected to, a pin. The component of the planet carrier may be a carrier disc, carrier shaft or base of the planet carrier retaining one or all of the pins. This allows a simple setup. Notably, also a setup is conceivable where the bearing oil chamber is located between a bore of the respective planet gear and an internal cylinder fixed on both sides to front and rear carrier plates via elastic elements.

Alternatively, the component of the journal bearing of the respective planet gear is a bushing and the component of the planet carrier is a pin arranged in the bushing. This allows a very direct acting of the elastic element(s).

Optionally, the at least one elastic element (of the journal bearing arrangement and/or the epicyclic gearbox) is a spring, e.g., made of a metal. Springs allow to tune the stiffness precisely. In general, the at least one elastic element can be an element that exerts a reactive force when it is compressed. For example, an elastic element may be an elastic preformed wedge, e,g., made of a sheet of metal.

Optionally, the at least one elastic element (of the journal bearing arrangement and/or the epicyclic gearbox) is arranged in a fluid, e.g., a liquid. By this, the heat produced by the deformation of the elastic element(s) can be dissipated effectively by the fluid. This thermal exchange may be particularly beneficial in case that an orbit of the sun gear, planet carrier or a planet gear sets in and remains sustained by the rotation of the rotor combined with the oil film action. The kinetic energy can be transformed in potential energy by the deformability of the elastic element.

The liquid may be an oil. Optionally, a system is provided to circulate the liquid, particularly an oil system to circulate the oil. This can further improve the dissipation of heat. The elastic element (s) of each elastic element arrangement may be located in a respective chamber (e.g., between seals). When added to an existing system (e.g., to seals or to a bearing squeeze film) the elastic elements can be designed and located so that a respective oil flow is not disturbed and the efficiency of the seal or squeeze film is not disrupted.

According to an aspect, an engine is provided. The engine comprises the journal bearing arrangement and/or the epicyclic gearbox according to any aspect or embodiment described herein. The engine may be an aircraft engine. The engine may further comprise a fan, wherein, optionally, the epicyclic gearbox is configured to drive the fan. For the engine, the advantages described above come into effect particularly strongly.

According to an aspect, a method of manufacturing an epicyclic gearbox with a planet carrier supported by a support structure, a ring gear, a sun gear, and planet gears having teeth is provided, for example the epicyclic gearbox according to any aspect or embodiment described herein. When assembled, the planet gears are meshing with the ring gear and with the sun gear, and each planet gear is rotatably mounted by means of a journal bearing, each of the journal bearings having a component providing a bearing surface for the respective planet gear, wherein a gap between the bearing surface and a (planet) surface of the planet gear is filled with an oil. The method comprises the steps of determining a support stiffness Ks with which the respective planet gear is supported, via its teeth, against the support structure; providing an elastic element arrangement with at least one deformable elastic element for at least one of the planet gears for elastically acting on the component of the journal bearing of the respective planet gear and a component of the planet carrier, wherein the elastic element arrangement is provided with a stiffness Kel that is smaller than the support stiffness Ks; and mounting the planet carrier, the ring gear, the sun gear, the planet gears and the elastic element arrangement to manufacture the epicyclic gearbox. For the advantages, reference is made to the above description of the epicyclic gearbox.

According to a further aspect, a method of manufacturing a journal bearing arrangement is provided. The journal bearing arrangement comprises a carrier supported by a (stiff) support structure and a rotatable element having a support surface and being rotatably mounted by means of a journal bearing, the journal bearing having a component providing a bearing surface for the rotatable element, wherein a gap between the bearing surface and a surface of the rotatable element is filled with an oil. The method comprises the steps of determining a support stiffness Ks with which the rotatable element (e.g., planet gear) is supported via the support surface (e.g., via its teeth) against the support structure; providing an elastic element arrangement with at least one deformable elastic element for elastically acting on the component of the journal bearing and a component of the carrier, wherein the elastic element arrangement has a stiffness Kel that is smaller than the support stiffness Ks; and mounting the carrier, the rotatable element and the component of the journal bearing to manufacture the journal bearing arrangement.

The component of the journal bearing may comprise one or more parts. The component of the carrier may comprise one or more parts.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox, Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 039, 038 0.37, 0.36, 0.35, 034, 0.33, 0.32, 0.31, 0.3, 0.29, 0.28, 0.27, 0,26, or 0.25, The ratio of the radius of the fan blade at the hub to the radius of the fan blade at the tip may be in an inclusive range bounded by any two of the values in the previous sentence (Le. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350cm, 360cm (around 140 inches), 370 cm (around 145 inches), 380 (around 150 inches) cm or 390 cm (around 155 inches). The fan diameter may be in an inclusive range bounded by any two of the values in the previous sentence (i.e, the values may form upper or lower bounds).

The rotational speed of the fan may vary in use. Generally, the rotational speed is lower for fans with a higher diameter. Purely by way of non-)imitative example, the rotational speed of the fan at cruise conditions may be less than 2500 rpm, for example less than 2300 rpm. Purely by way of further non-)imitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-)imitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Utip. The work done by the fan blades 13 on the flow results in an enthalpy rise dH of the flow. A fan tip loading may be defined as dH/Utip2, where dH is the enthalpy rise (for example the 1-D average enthalpy rise) across the fan and Utip is the (translational) velocity of the fan tip, for example at the leading edge of the tip (which may be defined as fan tip radius at leading edge multiplied by angular speed). The fan tip loading at cruise conditions may be greater than (or on the order of) any of: 0,3, 0.31, 0.32, 033, 0.34, 0.35, 0,36, 0.37, 0.38, 0,39 or 0.4 (all units in this paragraph being Jkg-1K-1/(ms-1)2). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15,5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1s, 105 Nkg-1s, 100 Nkg-1s, 95 Nkg-1s, 90 Nkg-1s, 85 Nkg-1s or 80 Nkg-1s, The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge,

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0,81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is an aircraft having a plurality of gas turbine engines.

FIG. 2 is a sectional side view of a gas turbine engine.

FIG. 3 is a close-up sectional side view of an upstream portion of a gas turbine engine.

FIG. 4 is a partially cut-away view of a gearbox for a gas turbine engine.

FIGS. 5A-5C show epicyclic gearboxes in planetary, star and solar arrangements.

FIGS. 6A-6D show various epicyclic gearboxes for the gas turbine engine of FIGS. 2 and 3, having elastic element arrangements.

FIG. 7 illustrates a deflection of a planet gear by gap-dependent periodic forces.

FIG. 8 illustrates the calculation of a stiffness of an elastic element arrangement in a given direction.

FIG. 9 is a diagram illustrating stiffnesses during a deflection due to a force on a planet gear.

FIG. 10 shows a method of manufacturing an epicyclic gearbox.

FIG. 11 shows a journal bearing arrangement.

FIG. 12 shows an eccentricity of a gap in a journal bearing versus time.

### DETAILED DESCRIPTION

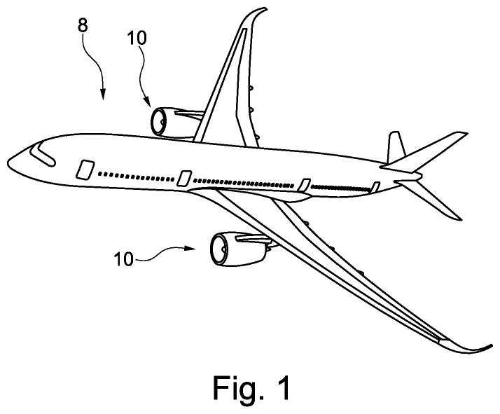

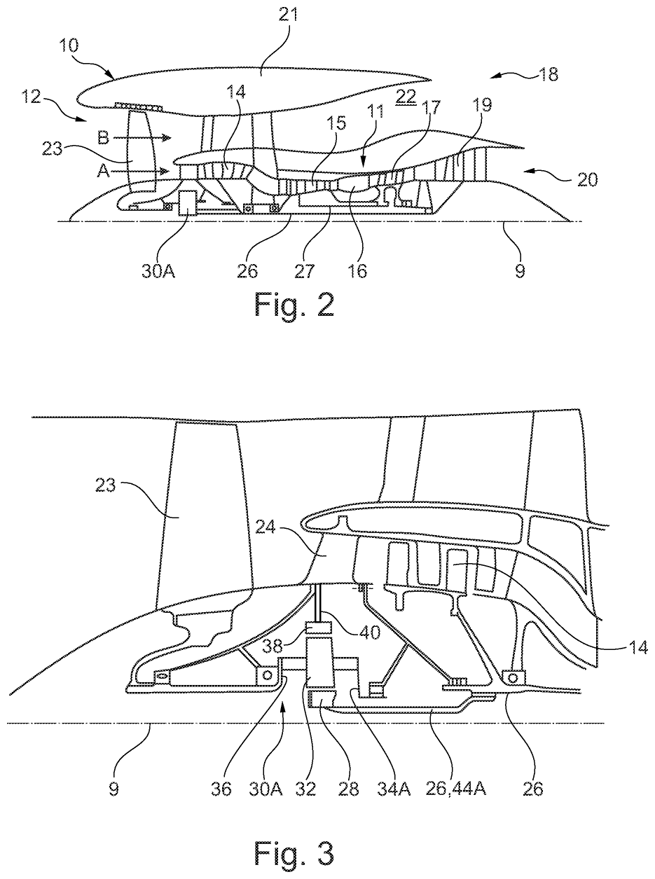

FIG. 1 shows an aircraft 8 in the form of a passenger aircraft, Aircraft 8 comprises several (i.e., two) gas turbine engines 10 in accordance with FIGS. 2 and 3.

FIG. 2 illustrates a gas turbine engine 10 having a principal rotational axis 9. The gas turbine engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30A, The shaft 26 in this example is a sun shaft 44A.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust, The high pressure turbine 17 drives the high pressure compressor 15 by a suitable interconnecting shaft 27. The fan 23 generally provides the majority of the propulsive thrust. The epicyclic gearbox 30A is a reduction gearbox.

An exemplary arrangement for a geared fan gas turbine engine 10 is shown in FIG. 3. The low pressure turbine 19 (see FIG. 2) drives the shaft 26, which is coupled to a sun wheel, or sun gear, 28 of the epicyclic gear arrangement 30A. Radially outwardly of the sun gear 28 and intermeshing therewith is a plurality of planet gears 32 that are coupled together by a planet carrier 34A. The planet carrier 34A constrains the planet gears 32 to precess around the sun gear 28 in synchronicity whilst enabling each planet gear 32 to rotate about its own axis, The planet carrier 34A is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

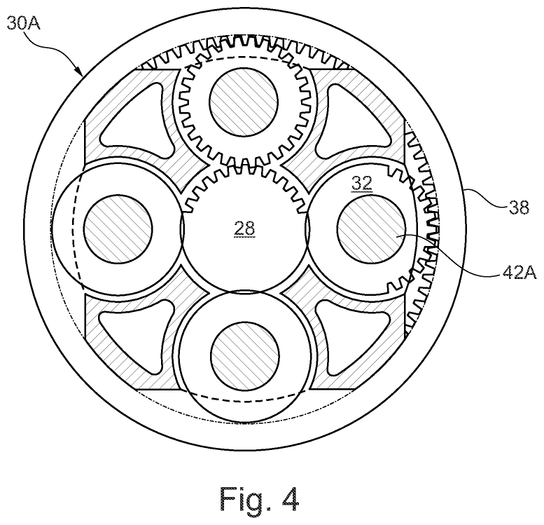

The epicyclic gearbox 30A is shown by way of example in greater detail in FIG. 4. Each of the sun gear 28, planet gears 32 and ring gear 38 comprise teeth about their periphery to intermesh with the other gears. However, for clarity only exemplary portions of the teeth are illustrated in FIG. 4. There are four planet gears 32 illustrated, although it will be apparent to the skilled reader that more or fewer planet gears 32 may be provided within the scope of the claimed invention (e.g., in FIG. 8, five planet gears are illustrated). Practical applications of a planetary epicyclic gearbox 30A generally comprise at least three planet gears 32. Each planet gear 32 is rotatably mounted on a component of the planet carrier 34A, which is a pin 42A in the present example, by means of a journal bearing.

It will be appreciated that the arrangement shown in FIGS. 3 and 4 is by way of example only, and various alternatives are within the scope of the present disclosure. Purely by way of example, any suitable arrangement may be used for locating the gearbox 30A in the engine 10 and/or for connecting the gearbox 30A to the engine 10, By way of further example, the connections (such as the linkages 36, 40 in the FIG. 3 example) between the gearbox 30A and other parts of the engine 10 (such as the input shaft 26, the output shaft and the support structure 24) may have any desired degree of stiffness or flexibility. By way of further example, any suitable arrangement of the bearings between rotating and stationary parts of the engine (for example between the input and output shafts from the gearbox 30A and the fixed structures, such as the gearbox casing) may be used, and the disclosure is not limited to the exemplary arrangement of FIG. 3. For example, where the gearbox 30A has a star arrangement (described below), the skilled person would readily understand that the arrangement of output and support linkages and bearing locations would typically be different to that shown by way of example in FIG. 3.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations, For example, such engines may have an alternative number of compressors and/or turbines and/or an alternative number of interconnecting shafts. By way of further example, the gas turbine engine shown in FIG. 2 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area Whilst the described example relates to a turbofan engine, the disclosure may apply, for example, to any type of gas turbine engine, such as an open rotor (in which the fan stage is not surrounded by a nacelle) or turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 2), and a circumferential direction (perpendicular to the page in the FIG. 2 view), The axial, radial and circumferential directions are mutually perpendicular,

The epicyclic gearbox 30A illustrated by way of example in FIGS. 3 and 4 is of the planetary type, in that the planet carrier 34A is coupled to an output shaft via linkages 36, with the ring gear 38 fixed.

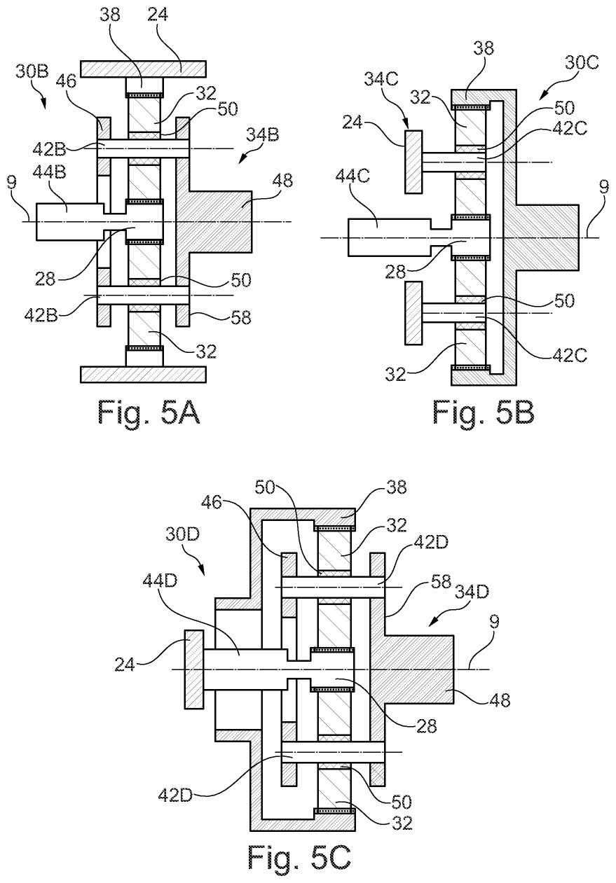

FIG. 5A shows another example of a planetary type gearbox 30B for the engine 10. The ring gear 38 is fixed to the support structure 24, the sun gear 28 is rotatable around the rotational axis 9 and driven by the sun shaft 44B. The planet carrier 34B is rotatable around the rotational axis 9 and comprises a carrier shaft 48, a base 58, pins 42B and a carrier disc 46. The base 58 is fixed to the carrier shaft 48. The pins 42B are mounted on the base 58 and on the carrier disc 46. A planet gear 32 is rotatably mounted on each of the pins 42B by means of a journal bearing 50. The planet gears 32 are arranged between the base 58 and the carrier disc 46.

However, any other suitable type of epicyclic gearbox may be used. By way of further example, as shown in FIG. 5B, an epicyclic gearbox 30C for the engine 10 may be a star arrangement, in which the planet carrier 34C is held fixed (or, as shown in FIG. 5B, is a part of the support structure 24), with the ring (or annulus) gear 38 allowed to rotate. In such an arrangement the fan 23 may be driven by the ring gear 38.

By way of a further alternative example, FIG. 5C shows a gearbox 30D for the engine 10 which is of a solar type in which the ring gear 38 and the planet carrier 34D are both allowed to rotate while the sun gear 28 is fixed with respect to the support structure 24 by means of the sun shaft 44D.

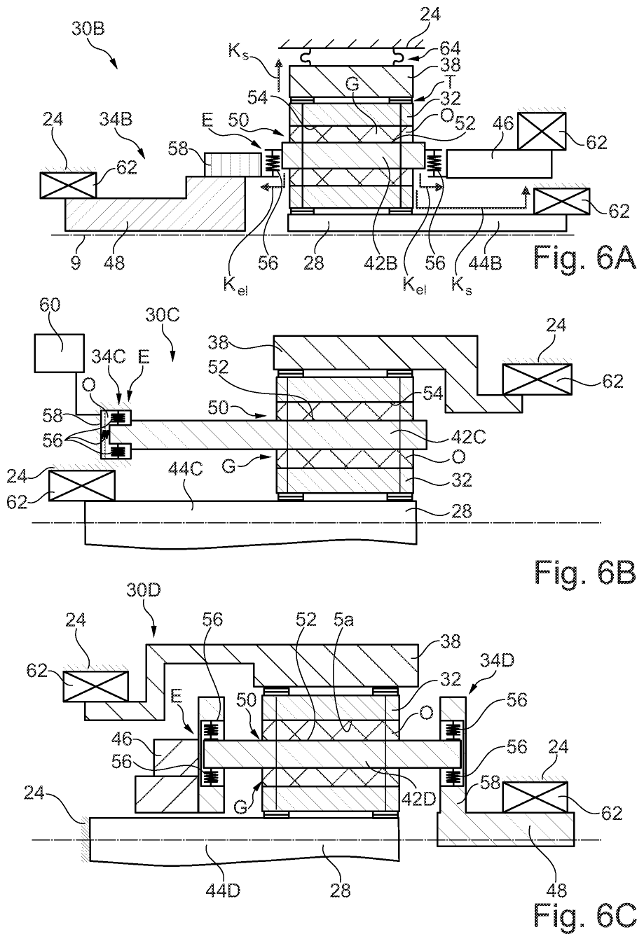

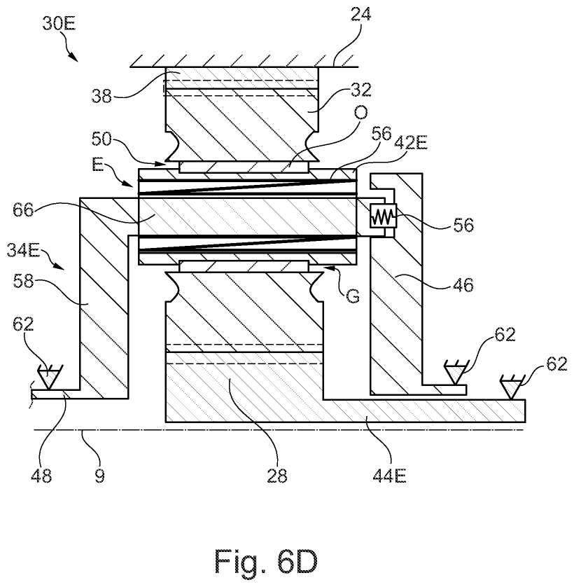

FIG. 6A shows an epicyclic gearbox 30B for an engine, particularly for the gas turbine engine 10 described above. The epicyclic gearbox 30B is of the planetary type. The epicyclic gearbox 30B comprises a ring gear 38. The ring gear 38 is mounted on the support structure 24 so as to prevent a rotation of the ring gear 38 with respect to the support structure 24. Specifically, the ring gear 38 is mounted on the support structure 24 by means of a flexible mounting 64. The flexible mounting 64 prevents a rotation of the ring gear 38 with respect to the support structure 24 but allows radial and axial movements of the ring gear 38 with respect to the support structure 24 up to a pre-defined extent.

The epicyclic gearbox 30B further comprises a sun gear 28. In this example, the sun gear 28 is fixed to a sun shaft 44B, which is rotatably supported on the support structure by means of a bearing 62.

The epicyclic gearbox 30B comprises a plurality of planet gears 32, wherein each planet gear 32 is in toothed engagement both with the ring gear 38 and with the sun gear 28. Each planet gear 32 is rotatably mounted on a planet carrier 34B by means of a journal bearing 50. The journal bearing 50 of each planet gear 32 comprises a component 42B providing a bearing surface 52 for the respective planet gear 32. In the present example, the component 42B of the journal bearing 50 is a pin. A circumferential gap G between the bearing surface 52 and a planet surface 54 of the respective planet gear 32 is filled with an oil O. The bearing surface 52 and the planet surface 54 are in contact with the oil O. The bearing surface 51 and the planet surface 54 define the annular gap G. Thus, the planet gear 32 is rotatably supported on the pin 42B. An optional oil system of the epicyclic gearbox 303 supports the oil 0 to the gap G.

Generally, for at least one of the planet gears 32, in this example for each of the planet gears 32, a respective elastic element arrangement E with generally at least one elastic element 56, in this example a plurality of elastic elements 56, is provided. The elastic element arrangement E is adapted to elastically act on the pin 42B (in general: the component of the journal bearing 50) of the respective planet gear 32 and at least one component 46, 58 of the planet carrier 34B.

The planet carrier 34B comprises a base 58 which is fixedly connected with a carrier shaft 48. The carrier shaft 48 is rotatably mounted on the support structure 24 by means of a bearing 62 (these bearings 62 may be roller bearings, e.g., ball bearings). The base 58 may have the shape of a disc, for example. Further, on the opposite side of the planet gear 32, the planet carrier 34B comprises a carrier disc 46. The carrier disc 46 is rotatably mounted on the support structure 24 by means of a bearing 62.

Each pin 42B is held on the base 58 and on the planet disc 46 by means of the elastic element arrangement E. More specifically, each pin 42B is connected to the base 58 via a plurality of elastic elements 56 and is connected to the carrier disc 46 via a further plurality of elastic elements 56. The elastic elements 56 allow a radial movement (alternatively or additionally an axial movement) of the pin 42B with respect to the base 58 and the carrier disc 46.

Thus, the ring gear 38 and the sun gear 28 are (sun gear 28: rotatably, ring gear 38: fixedly with respect to a rotation around the rotational axis 9) supported on the support structure 24 so that the planet surface 54 of each planet gear 32 is supported against the support structure 24 via the ring gear 38 and the sun gear 28. This support has a stiffness which is referred to as support stiffness Ks.

The elastic element arrangement E has a stiffness Kel.

It is provided that the stiffness Kel of the elastic element arrangement E is smaller than the support stiffness Ks, particularly by two orders of magnitude. For example, the stiffnesses are designed as follows: Kel<0.01*Ks. As an example, the stiffness Kel of the elastic element arrangement E is smaller than the stiffness of the flexible mounting 64. The stiffness Kel and the support stiffness Ks may be determined with respect to a radial direction (and/or with respect to an axial direction and/or with respect to a tangential direction).

As a result, when oil-induced forces lead to an orbiting motion of the planet gear 32 with respect to the pin 42B, first the elastic elements 56 are deformed, before a substantial deformation of the planet gear 32, ring gear 38, sun gear 28, and the mounting of the ring gear 38 via the flexible mounting 64, and of the sun gear 28 via the sun shaft 44B and the bearing 62 on the support structure 24.

Also, the components 58, 46 of the planet carrier 34B, in this example the base 58 and the carrier disc 46, are supported against the support structure 24 with a carrier stiffness Kca (which may be equal on either side). The stiffness Kel of the elastic element arrangement E is also smaller than the carrier stiffness Kca. In the present example, the stiffness Kel of the elastic element arrangement E is half of the carrier stiffness Kca or lower.

In particular in aircraft engines, a deterioration of the initial alignment of rotors, for instance caused by changes in radial and axial clearances or in angular misalignrnents between rotors and between rotors and stators is known to drive vibrations. In particular, gap-dependent forces can be developed when the gaps G between rotors and stators lose the circumferential symmetry and as a result of this, an unbalanced oil pressure (or air gap pressure such as in turbines and compressors) exert a resultant force onto the rotors that may cause vibrations and instable orbits (e.g., oil whirl and whip in the journal bearings 50). In general, when a misaligned rotor is rotated about its rotational axis and experiences a radial load, an oil film in a clearance exerts a hydrodynamic pressure on the sliding surface of the rotor, and the rotor is forced into an eccentric arrangement relative to its carrier. A location of maximum pressure follows the location of the minimum oil film thickness and rotates while the rotor spins, generating tangential forces (proportional to the friction coefficient) that in certain circumstances might start a precession orbital motion, backward or forwards, with respect to the rotor spinning.

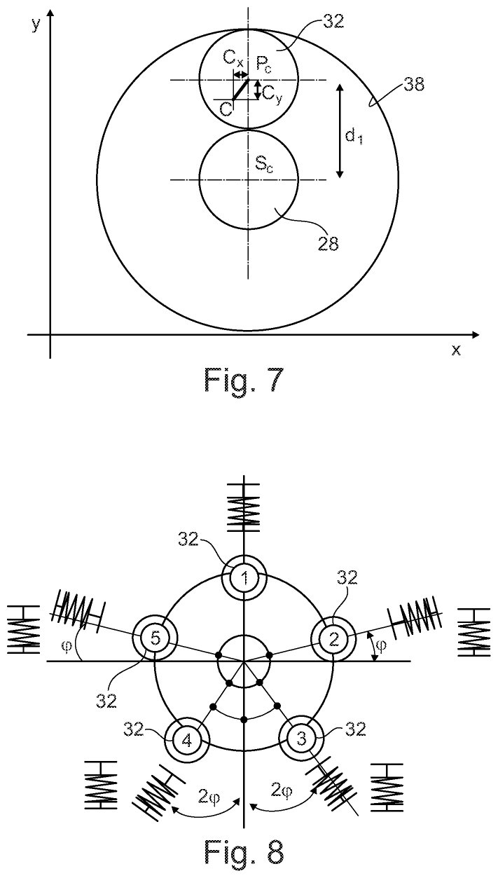

FIG. 7 shows, as an example, the sun gear 28 with its center Sc and one of the planet gears 32 with its center Pc. The center C of the pin 42B of the planet gear 32 is also indicated. Here, the planet gear 32 is shown to be eccentric to the pin 42B center C with offsets Cx and Cy in the plane perpendicular to the rotational axis of the planet gear 32. Solely for illustration, this eccentricity is magnified. The planet center Pc and the sun center Sc have a distance dl which depends on the presence of an orbiting motion of the planet gear 32.

Due to the arrangement of the elastic elements 56, and their stiffnesses, oil-induced vibrations primarily lead to deformations of the elastic elements 56. These deformations convert the energy of the motion into potential energy and because of the structural damping the reactive relative displacement Pc-C is reduced. This reduction causes in turn the oil forces due to the overpressure to be reduced in intensity so that the orbit does not kick in or is reduced . This allows to reduce the wear of the other components of the epicyclic gearbox 308, and thereby increase its lifetime and reliability. The insertion of the elastic elements may introduce a natural frequency of bouncing. This can be easy calculated and a risk connected to a cyclic vibration can be reduced e.g., by augmenting a modal damping of monitoring the noise at such frequency.

The relative displacements between C-Pc are directly proportional to the gap variation in the journal bearing oil film. Advantageously, the same elastic elements 56 also deform when the segment C-Pc changes, because of movements of the ring gear 38 mounting or of the sun shaft center Sc, so that not the entire displacement is transmitted rigidly but only a part. The stiffness of the elastic element arrangement, e.g., in a planetary gear train, is softer (lower) than the gear train mesh point connections stiffness, than the oil film and roller bearing stiffness and than the gear and shaft stiffness. In general, the ring mounting stiffness is designed to be lower than the above mentioned stiffness, however when the elastic element 56 is inserted with the scope of reducing the orbits due to gap variation, its stiffness is smaller than the mounting stiffness (e.g. less than half or smaller).

Returning to FIG. 6A, the elastic element arrangement E is designed so as to prevent rotation of the component (the pin 42B) of the journal bearing 50 with respect to the component (carrier disc 46 and base 58) of the planet carrier 34B around the rotational axis of the planet gear 32. For example, the elastic elements 56 extend along a section around the rotational axis of the planet gear 32. E.g., each of the elastic elements 56 has a length (e.g., in radial direction), a width (e.g., in circumferential direction) and a thickness (e.g., in axial direction), wherein the length and width are both (for example, three, five or ten times) larger than the thickness. These proportions are solely presented as an example and other dimensions are conceivable. Each of the elastic elements 56 may be a spring. For example, some or each of the elastic elements 56 may be made of spring steel

The elastic element arrangement E of each planet gear 32 comprises a plurality of the elastic elements 56, e.g., three or more elastic elements 56 on each side of the respective planet gear 32.

Each elastic element 56 has a certain individual stiffness. The stiffness Kel of the elastic element arrangement E is calculated in a given direction (e.g., for a given angle around the pin 42B center Pc) as equivalent stiffness of all contributing stiffnesses which may include the sum of the stiffness values of individual elastic elements 56 with respect to the given direction.

FIG. 8 illustrates equivalent stiffnesses (illustrated as springs) for a vertical direction and radial directions, as an illustrative example. For example, the stiffness Kel of the elastic elements is designed to be

$${K}_{el} \geq \frac{\sum {L}_{i}}{{\overline{( {P}_{c}} - C )}_{max}}$$

where Li include one or more, particularly all of he following loads:
a) Nominal loads that are generated to sustain speed and/or torque steady states;
b) Transient loads (due to acceleration/deceleration/air flow equation/gust loads e
c) Load modulations due to sustained load fluctuations consequent to a periodic variation of an oil gap between at least one rotating component of the gear-train and/or a variation of an oil/air gap in the engine turbomachinery;
d) Load or displacement modulations due to natural frequencies being excited by driving forces having coincident frequency and congruent phase;
e) Load modulation due to sustained load fluctuations by an interaction of loads on structural components and due to a control system;
f) Modulations of transmitted power fluctuations, induced by ovalization of splines; even though they are not a direct cause of sustained carrier/sun orbits, they can modulate the external load acting on the journal bearing 50 and as such provoke a reactive modulation.

Stiffnesses that act in parallel, are combined by calculating their sum, Stiffnesses Ki that act in series, are combined as follows:

$${K}_{series} = \frac{1}{{\sum }_{n} \frac{1}{{K}_{i}}}$$

Thus, the support stiffness Ks is calculated as the inverse of the sum of inverse stiffness values, wherein the inverse stiffness values comprise inverse stiffness values of the ring gear 38, the sun gear 28, the planet gear 32 and their respective mounts on the support structure 24. The inverse stiffness values may further comprise the oil film stiffness of the oil O in the gap G, so the support stiffness Ks may be determined for various speed and torque conditions. The stiffness Kel of the elastic element arrangement E may be designed to be (e.g., one or two orders of magnitude) lower than the support stiffness Ks at all of the plurality of speed and torque conditions. In particular, the support stiffness Ks is calculated using stiffness values for all components on all paths via which forces acting in the gap G may be transferred to the support structure 24 except the path via the elastic element arrangement E. The support structure 24 may be regarded as being stiff.

Turning now to FIG. 6B, an example for an epicyclic gearbox 30C with a star arrangement is shown. The ring gear 38 is rotatably mounted on the support structure 24 by means of a bearing 62. The sun gear 28 is rotatably mounted on the support structure 24 via the sun shaft 44C and by means of a bearing 62.

The planet carrier 34C is formed by a part of the support structure 24 serving as the planet carrier 34C base 58. The component of the planet carrier 34C is the base 58. The component of the journal bearing 50 of each planet gear 32 is a respective pin 42C. The pin 42C is supported on the base 58 by means of an elastic element arrangement E comprising a plurality of elastic elements 56. Specifically, the pin 42C is supported on the base 58 by means of the elastic element arrangement E on one end of the pin 42C, wherein the other end is free. Alternatively, the other end could be supported, optionally via further elastic elements, on a carrier disc, similar to FIG. 6A. The supported end of the pin 42C is received in a pocket of the base 58. The base 58 (with the pocket) defines maximal deflections of the pin 42C in the radial (and axial) directions.

As shown in FIG. 6B, the elastic element arrangement E comprises elastic elements 56 that act in a radial direction and another elastic element 56 that acts in an axial direction (with respect to the rotational axis of the planet gear 32). Alternatively, or in addition, the elastic element arrangement E may comprise an elastic element 56 that acts in a radial direction and in an axial direction (for example, the elastic elements 56 shown in FIG. 6A may also act in axial direction).

Further, the elastic elements 56 are arranged in a liquid (more general, a fluid). Specifically, the liquid is an oil, wherein an optional oil system 60 is arranged to provide and, e.g., to circulate the oil. This oil (or other liquid) may serve to cool the elastic elements for dissipating the heat. Seals are provided to contain the oil 0 in the pocket

FIG. 6C shows an example for an epicyclic gearbox 30D with a solar arrangement. The sun gear 28 is fixed to the support structure 24 via the sun shaft 44D. The ring gear 38 is rotatably mounted on the support structure 24 by means of a bearing 62. The planet carrier 34D is rotatably mounted on the support structure 24 by means of a further bearing 62.

The planet carrier 34D comprises a carrier disc 46 and a base 58. The base 58 is rotatably mounted on the support structure 24 by means of a bearing 62 via a carrier shaft 48. The carrier disc 46 is free and itself not supported on the support structure 24. An elastic element arrangement E comprises elastic elements 56 on both sides of the planet gear 32. The pin 42D is pretensioned against the carrier disc 46 at one end and to the base 58 at the other end.

FIG. 6D shows another example of an epicyclic gearbox 30E of the planetary type. The planet carrier 34E comprises a carrier disc 46 and a base 58. The base 58 is rotatably mounted on the support structure 24 by means of a bearing 62 via a carrier shaft 48. The carrier disc 46 is rotatably mounted on the support structure 24 by means of another bearing 62. The sun gear 28 is rotatably mounted on the support structure 24 via the sun shaft 44E and by means of a further bearing 62.

The journal bearing 50 comprises a component in the form of a bushing 42E. The planet carrier 34E comprises a component in the form of a pin 66. Between the bushing 42E and the pin 66 elastic elements 56 of an elastic element arrangement E are provided. The pin 66 is arranged inside the bushing 42E. The elastic elements 56 are arranged around the pin 66.

Another elastic element 56 is provided to axially support the pin 66 against the carrier disc 46. Notably, an axial load is commonly mainly created due to moments generated by radial loads that are variable along the bearing axial direction.

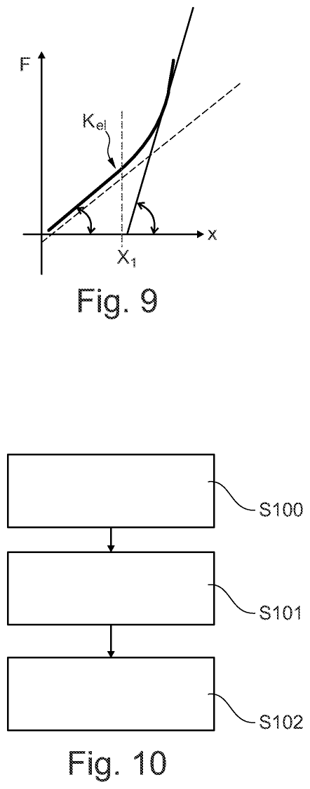

FIG. 9 illustrates the stiffness Kel of the elastic element arrangement E in a diagram of the applied force versus a deforming deflection along a direction x. In general, the stiffness can be defined as the applied force divided by the corresponding deformation. The stiffness Kel of the elastic element arrangement E is linear up to a predetermined deflection x1 Beyond x1, plastic deformations may take place, depending on the design of the elastic elements 56. A stop or additional elastic elements that only come are deformed at certain deflections may be mounted to avoid deflections beyond x1. Alternatively, elastic elements are applied that are elastic over their whole range of possible deflections in the journal bearing arrangement and/or epicyclic gearbox.

FIG. 10 shows a method of manufacturing an epicyclic gearbox, e.g., one of the epicyclic gearboxes 30A-30E described above, with a planet carrier 34A-34E supported by a support structure 24, a ring gear 38, a sun gear 28, and planet gears 32 wherein, when assembled, the planet gears 32 are meshing with the ring gear 38 and with the sun gear 28, and each planet gear 32 is rotatably mounted (e.g., on the planet carrier 34A-34E) by means of a journal bearing 50, the journal bearing having a component 42A-42E (e.g., a pin or a bushing) providing a bearing surface 52 for the respective planet gear 32, wherein a circumferential gap G between the bearing surface 51 and a planet surface 54 of the planet gear 32 is filled with an oil O. The method comprises the following steps:

Step S100: Determining a support stiffness Ks with which the respective planet gear 32 is supported (via its teeth T) against the support structure 24.

Step S101: Providing an elastic element arrangement E with at least one deformable elastic element 56 for at least one of the planet gears 32 for elastically acting on the component 42A-42E of the journal bearing 50 of the respective planet gear 32 and a component 46; 48; 58; 66 (e.g., a carrier disc, base or shaft, or a pin fixed on the planet carrier) of the planet carrier 34A-34E, wherein the elastic element arrangement E is provided with a stiffness Kel that is smaller than the support stiffness Ks.

Step S102: Mounting the planet carrier 34A-34E, the ring gear 38, the sun gear 28, the planet gears 32 and the elastic element arrangement E to manufacture the epicyclic gearbox 30A-30E.

The elastic elements 56 can be dimensioned by an FEM-model where the oil film displacements generated by the journal bearing loads may also be accounted for.

For example, the radial stiffness of the following components is accounted for when calculating relative displacements: ring gear+ring gear mounting, planet gear, oil film radial stiffness (this is in general different at each speed/torque conditions, so the calculation may be made for various speed and torque conditions), planet carrier pin, planet carrier shaft, planet carrier shaft bearings, sun gear and sun gear bearings.

The component 42A-42E of the journal bearing 50 connects the planet carrier 34A-34E with the respective planet gear 32. The component 46; 48; 58; 66 of the planet carrier 34A-34E connects the component 42A-42E of the journal bearing 50 (via the elastic elements 56) to the support structure 24.

The elastic elements 56 are arranged at predefined locations. The elastic elements 56 can be referred to as localized elastic elements. The elastic elements 56 are configured to absorb, by means of their own deformation, the initial reactive force due to an initial gap decrease, that in general can be provoked by a number of contributors (e.g. transient, static and dynamic forces combined during a flight condition). With respect to the other driveline elements, the stiffness of the elastic elements in radial and axial direction is dimensioned so that when the planet gears 32 undergo orbits the spring elements are those that are deformed at first, because the stiffness and deformation amount are dimensioned in a way that prevents the other components to be deformed at the same time. The localized elastic elements are designed to be capable of absorbing the first reactive movement due to the oil film reaction to the initial Pc-C displacement and, by means of that, to reduce the incipit of cyclic orbits. The design of the elastic elements 56, e.g., springs, accounts of the clearance stack-up versus the speed-torque conditions in the flight envelope. It is worth noting that the center of the planet gear undergoes a further variable stiffness constraint because of flank contacts being present on both sides, which may variate lock the ability to orbit depending on torque and speed and oil trapping unexpected effects (so called floating planet) as the planet gear is an idler gear that meshes at the same time with sun gear and ring gear.

When an onset of displacements that provokes a gap reduction sets in, the elastic elements 56 are initially the first elements of the gear train to be deformed, without any plasticity, under the oil film reactive loads consequent to the initial gap variation. Such gap variation can be initiated by a relative movement between the planet gear 32 and the pin, or, for example, a deformation of the pin, a movement of the sun, a load on the fan, a modal vibration amplified by a flexible ring gear etc. The deformation of the elastic elements 56 allows to absorb into strain energy and dissipate for hysteresis the initial peak of kinetic energy so that none of the rotors of the epicyclic gearbox will start to precession or the precession will be largely diminished.

Since it is commonly not possible prevent all sources of relative displacement (see FIG. 7), elastic elements localized between each planet journal bearing and the respective pin or between the pin(s) and the carrier shaft is proposed.

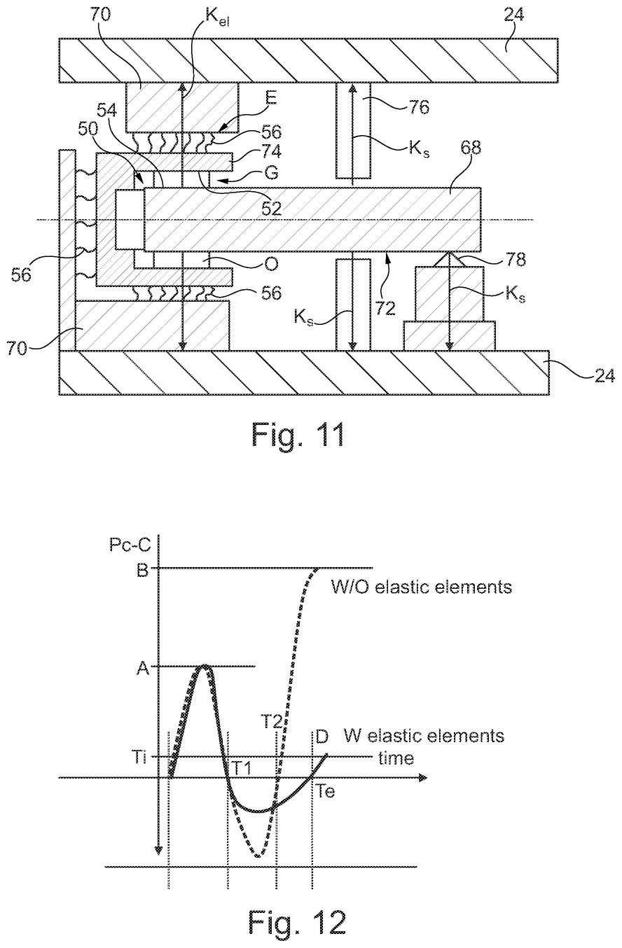

FIG. 11 shows a bearing 50 arrangement comprising a carrier 70 supported by (here: fixedly connected to; alternatively, e.g., rotatably connected to) a support structure 24. The support structure 24 may be regarded as infinitely stiff,

The bearing 50 arrangement further comprises a rotatable element 68 which is a shaft in the present example, The rotatable element 68 has a support surface 72 and is rotatably mounted on the support structure 24 by means of the bearing 50 which in the present example is a journal bearing. The bearing 50 has a component 74 providing a bearing surface 52 for the rotatable element 68 (here: both in radial and axial directions with respect to a rotational axis of the rotatable element 68). Therein, a gap G between the bearing surface 52 and a surface 54 (here: an outer surface) of the rotatable element 32 is filled with an oil O or another fluid (again both in radial and axial directions).

Therein, an elastic element arrangement E with at least one deformable elastic element 56 is provided so as to elastically act on the component 74 of the bearing 50 and a component 76 of the carrier 70, wherein the rotatable element 68 is supported via its support surface 72 against the support structure 24 with a support stiffness Ks (here as a combined stiffness via various load paths via a magnetic bearing 76 and a bearing 78 in this example), and wherein the elastic element arrangement E has a stiffness Kel that is smaller than the support stiffness Ks.

The support stiffness Ks is calculated from all the supports of the rotatable element 68 (here: the shaft) to the support structure 24 by geared connections, friction disks, magnetic bearings, electrical machine unbalanced magnetic pulls etc., equivalent to springs, in series and/or in parallel.

Notably, the gap G may fillied with a liquid, such as the oil 0. Alternatively, the gap G may be filled with a gas or gas mixture, such as air. The arrangement may also be a seal, a squeeze film device, a magnetic bearing or an electrical machine such as a motor (and/or generator), radial or axial. In the case of a magnetic bearing or an electrical machine the gap G may be filled with air. In the case of the electrical machine the carrier 70 may be a stator, wherein the rotatable element includes or is a rotor of the electrical machine.

In FIG. 11 the stiffness Kel is the resultant stiffness of all elastic elements 56 of the elastic element arrangement E. The stiffness of the carrier 70 and bearing 78, in different load paths, are also accounted in a resultant stiffness. Once the elastic elements 56 are added, then due to their lower stiffness in comparison with all other elements, the radial and/or axial deformation will be largely determined by the elastic element arrangement E, whereas the other components will remain rigid. The elastic elements 56 will work to absorb the relative displacements that are generated as reaction to the gap variation if there is any other very deformable element in the load paths such as deformable rig gear mountings, s-shaped bendings in shafts etc.

The journal bearing gap is filled with oil. The same design concept and position of the elastic elements 56 can be applied to a gap of a seal, of a squeeze-film bearing, of an air bearing, of a magnetic bearing or to the air gap of an electrical motor, radial or axial.

FIG. 12 shows a qualitative example of the first transient gap variation Pc-C (see FIG. 7) versus time, that triggers an orbit of some of the rotors in a gearbox. It should be noticed that the orbit that is generated by the oil film gap variation because of the reactive pressure loads can be excited on the planet carrier, on the sun gear or on one or more planet gears. Therefore, the diagram is not representing the orbit but the first relative displacement Pc-C that generates the overpressure in the journal bearing, squeeze film or seal. The two curves compare a very stiff carrier-pin connection design without elastic elements with a flexible one, where a localized elastic element, such a radial spring, deforms when Pc-C changes. The time length Ti-T1 and T1-Te are an example of a case in which the spring introduces an amount of structural damping that is able to reduce the reactive action of the pressure (from B to D) as a consequence of the deformation of the spring.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

### LIST OF REFERENCE NUMBERS

8 airplane
9 rotational axis
10 gas turbine engine
11 engine core
12 air intake
14 low-pressure compressor
15 high-pressure compressor
16 combustion equipment
17 high-pressure turbine
18 bypass exhaust nozzle
19 low-pressure turbine
20 core exhaust nozzle
21 nacelle
22 bypass duct
23 propulsive fan
24 support structure
26 shaft
27 interconnecting shaft
28 sun gear
30A-30E gearbox
32 planet gear
34A-34E planet carrier
36 linkages
38 ring gear
40 linkages
42A-42D pin (component of journal bearing)
42E bushing (component of journal bearing)
44A-44E sun shaft
46 carrier disc (component of planet carrier)
48 carrier shaft (component of planet carrier)
58 journal bearing
52 bearing surface
54 planet surface
56 elastic element
58 base (component of planet carrier)
60 oil system
62 bearing
64 flexible mounting
66 pin (component of planet carrier)
68 shaft
70 carrier
72 support surface
74 component
76 magnetic bearing
78 bearing
A core airflow
B bypass airflow
E elastic element arrangement
G gap
Kel stiffness of elastic element
Ks support stiffness
O oil
T teeth

1. A bearing arrangement comprising:
a carrier supported by a support structure and
a rotatable element having a support surface and being rotatabiy mounted by means of a bearing, the bearing having a component providing a bearing surface for the rotatable element, wherein a gap between the bearing surface and a surface of the rotatable element is filled with a fluid;
wherein an elastic element arrangement with at least one deformable elastic element is provided so as to elastically act on the component of the bearing and a component of the carrier, wherein the rotatable element is supported via its support surface against the support structure with a support stiffness, and wherein the elastic element arrangement has a stiffness that is smaller than the support stiffness.

2. The bearing arrangement of claim 1, wherein the rotatable element is a gear and wherein the support surface forms teeth of the gear.

3. The bearing arrangement of claim 1, being a bearing arrangement of an aircraft engine.

4. An epicyclic gearbox comprising:
a planet carrier supported by a support structure;
a ring gear;
a sun gear; and
planet gears, each having teeth and meshing with the ring gear and with the sun gear, wherein each planet gear is rotatably mounted by means of a journal bearing, each of the journal bearings having a component providing a bearing surface for the respective planet gear, wherein a gap between the bearing surface and a surface of the planet gear is filled with an oil;
wherein for at least one of the planet gears an elastic element arrangement with at least one deformable elastic element is provided so as to elastically act on the component of the journal bearing of the respective planet gear and a component of the planet carrier, wherein the planet gears are supported via their teeth against the support structure with a support stiffness, and wherein the elastic element arrangement has a stiffness that is smaller than the support stiffness.

5. The epicyclic gearbox according to claim 4, wherein the stiffness of the elastic element arrangement is at least 10 times smaller than the support stiffness.

6. The epicyclic gearbox according to claim 4, wherein the stiffness of the elastic element arrangement is at least 100 times smaller than the support stiffness.

7. The epicyclic gearbox according to claim 4, wherein the elastic element arrangement prevents rotation of the component of the journal bearing with respect to the component of the planet carrier.

8. The epicyclic gearbox according to claim 4, wherein the elastic element arrangement comprises a plurality of elastic elements.

9. The epicyclic gearbox according to claim 8, wherein the stiffness of the elastic element arrangement is calculated in a given direction as the equivalent stiffness resulting from the stiffness values of the individual elastic elements with respect to the given direction.

10. The epicyclic gearbox according to claim 4, wherein the support stiffness is calculated as the inverse of the sum of inverse stiffness values, wherein the inverse stiffness values comprise inverse stiffness values of the ring gear, the sun gear, the planet gear and their respective mounts on the support structure.

11. The epicyclic gearbox according to claim 4, wherein an elastic element arrangement is provided for each of the planet gears.

12. The epicyclic gearbox according to claim 4, wherein the elastic element arrangement comprises an elastic element that acts in a radial direction and another elastic element that acts in an axial direction, or an elastic element that acts in a radial direction and in an axial direction.

13. The epicyclic gearbox according to claim 4, wherein the component of the journal bearing of the respective planet gear is a pin and the component of the planet carrier is a carrier disc, carrier shaft or base of the planet carrier retaining a plurality of pins.

14. The epicyclic gearbox according to claim 4, wherein the component of the journal bearing of the respective planet gear is a bushing and the component of the planet carrier is a pin arranged in the bushing.

15. The epicyclic gearbox according to claim 4, wherein the at least one elastic element is a spring.

16. The epicyclic gearbox according to claim 4, wherein the at least one elastic element is arranged in a liquid, wherein the liquid is an oil, wherein an oil system is provided to circulate the oil.

17. The epicyclic gearbox according to claim 4, being an epicyclic gearbox of an aircraft engine.

18. A method of manufacturing an epicyclic gearbox with a planet carrier supported by a support structure, a ring gear, a sun gear, and planet gears having teeth wherein, when assembled, the planet gears are meshing with the ring gear and with the sun gear, and each planet gear is rotatably mounted by means of a journal bearing, each of the journal bearings having a component providing a bearing surface for the respective planet gear, wherein a gap between the bearing surface and a surface of the planet gear is filled with an oil, the method comprising:
determining a support stiffness with which the respective planet gear is supported via its teeth against the support structure;
providing an elastic element arrangement with at least one deformable elastic element for at least one of the planet gears for elastically acting on the component of the journal bearing of the respective planet gear and a component of the planet carrier, wherein the elastic element arrangement is provided with a stiffness that is smaller than the support stiffness; and
mounting the planet carrier, the ring gear, the sun gear, the planet gears and the elastic element arrangement to manufacture the epicyclic gearbox.
